(19) United States
(12) Patent Application Publication
(10) Pub. No.: US 2014/0267730 A1
(43) Pub. Date: Sep. 18, 2014

(54) AUTOMOTIVE CAMERA VEHICLE INTEGRATION

(71) Applicants: Carlos R. Montesinos, Santa Clara, CA (US); Victoria S. Fang, Mountain View, CA (US); Paul Clifton, East Point, GA (US); Truc Nguyen, Chandler, AZ (US); Joshua I. Ekandem, Clemson, SC (US); Jerone Dunbar, Central, SC (US)

(72) Inventors: Carlos R. Montesinos, Santa Clara, CA (US); Victoria S. Fang, Mountain View, CA (US); Paul Clifton, East Point, GA (US); Truc Nguyen, Chandler, AZ (US); Joshua I. Ekandem, Clemson, SC (US); Jerone Dunbar, Central, SC (US)

(21) Appl. No.: 13/840,140

(22) Filed: Mar. 15, 2013

(51) Int. Cl. H04N 7/18

(52) U.S. Cl. CPC H04N 7/183
USPC 348/148

(57) ABSTRACT

Systems and methods may provide for a handheld computing device to receive a trigger command and orientation data from a remote computing device, obtain image data from one or more external devices in response to the trigger command and based on the orientation data, and transmit data to the remote computing device. A vehicle computer may receive a trigger command and orientation data from a remote computing device, obtain image data from one or more external devices in response to the trigger command and based on the orientation data, and transmit data to the remote computing device.

### FIELD OF THE INVENTION

Embodiments described herein generally relate to interfacing mobile devices with an automotive computer system, and more particularly to interfacing mobile devices with an automotive computer system to capture images.

### BACKGROUND

Many mobile devices include a camera to capture photographic images. These photographic images may be captured anywhere, such as, indoors, outdoors and inside an automobile. When a user captures a photographic image of a remote object while inside an automobile, the interior of the automobile may also be captured in the photographic image. This effect may diminish the quality of the photographic image.

### BRIEF DESCRIPTION OF THE DRAWINGS

The various advantages of the embodiments of the present invention will become apparent to one skilled in the art by reading the following specification and appended claims, and by referencing the following drawings, in which:

FIGS. 1A and 1B are block diagrams of examples of integration systems according to embodiments;

FIG. 2 is an illustration of field of view ranges according to an embodiment;

FIG. 3 is a block diagram of an example of a system according to an embodiment;

FIG. 4 is a block diagram of an example of a processor according to an embodiment;

FIGS. 5A and 5B are flowcharts of examples of methods according to embodiments; and

FIGS. 6A and 6B are pictorial examples of the method according to an embodiment.

### DETAILED DESCRIPTION

Turning now to FIGS. 1A and 1B, an integration system 10 is shown including a handheld computing device 11, an electronic compass 12, a vehicle computer 13, a 360 degree field of view camera system 14, and network system 15. Although the embodiment illustrates one handheld computing device, the system may include a plurality of handheld computing devices. The illustrated integration system 10 integrates the handheld computing device 11, vehicle computer 13 and camera system 14 into one unified system.

The handheld computing device 11 may be any computing processing device, such as, for example, a mobile phone, laptop, tablet, or any kind of handheld computer processing system. Each handheld computing device may include a processor, memory, communication modules, display, user interface, camera and application programs. The communication modules may include a wireless local area network (WLAN), Bluetooth technology, dedicated short range communication technology (dsrc), global positioning system and radio frequency (RF) links. Each device may include an electronic compass 12, such as, for example, a fiber optic gyrocompass or a magnetometer.

The handheld computing device 11 may also include a controller and data storage device (e.g., flash memory, read only memory (ROM), electrically erasable programmable read only memory (EEPROM)). The controller may include one or more microprocessors, computer readable memory (e.g., read-only memory (ROM), random access memory (RAM), mechanisms and structures for performing input/output (I/O) operations. The controller may execute an operating system for execution on the central processing unit and one or more application programs to control the operation of the handheld computing device(s). The data storage device stores data, the operating system and one or more application programs.

The handheld computing device 11 may generally include modules to receive information from a user interface to initiate a trigger command, obtain orientation data and send the orientation data and the trigger command to a remote computing system, and to receive a response from the remote computing system including one or more external images. The modules may include processors embedded with computer readable instructions that when executed perform various functions.

In one example, the handheld computing device 11 includes a user interface (UI) 16 to obtain information from a user to initiate a trigger command and a first receive module 17 to receive the information from the UI 16. The illustrated computing device 11 also includes an orientation module 18 to send orientation data and the trigger command to a remote computing system associated with a vehicle. The orientation data may include, for example, location data (e.g., image data, digital compass data global positioning system/GPS data) relative to an object of interest. The object of interest may be any object of which the user is requesting a photographic image. In one example, the orientation module 18 sends the orientation data and the trigger command to the vehicle computer 13. The computing device 11 may also include a second receive module 19 to receive a response from the remote computing system, wherein the response includes one or more images of a scene external to the vehicle.

The vehicle computer 13 may include a computer embedded in a vehicle, such as, for example, a car, bus, motorcycle, van, sports utility vehicle, etc. The computer may be embedded for example, on a motherboard which may be attached to the structure of the vehicle.

The vehicle computer 13 may include a multiprocessor system, as illustrated in FIG. 3, communication modules, a camera interface unit and application programs. The communication modules may include a wireless local area network (WLAN), Bluetooth technology, dedicated short range communication technology (dsrc), global positioning system, and radio frequency (RF) links.

In one example, the vehicle computer 13 includes a receive module 20 to receive a trigger command and orientation data from a remote computing device such as, for example, the handheld computing device 11, and an obtain module 21 to obtain image data from one or more devices external to the vehicle in response to the trigger command and based on the orientation data. The vehicle computer 13 may also include a transmit module 22 to transmit data to the remote computing device. The illustrated vehicle computer 13 also includes a select module 23 to select one or more of the devices external to the vehicle to obtain the image data based on the received orientation data, and a crop module 24 to crop the image data from the one or more devices external to the vehicle. Thus, the data transmitted to the remote computing device may include the cropped image data obtained from the one or more external devices.

The 360 degree field of view camera system 14 may include a controller, memory, a front view camera, a right side view camera, left side view camera, and rear view camera. Each camera may have a limited field of view, as illustrated in the field of view diagram 25 of FIG. 2. Collectively, however, the illustrated plurality of cameras provide a 360 degree field of view.

The plurality of cameras may be mounted externally to a vehicle. Each camera may be mounted on the vehicle at a location or position to capture images within a particular field of view relative to the vehicle. For example, the front view camera may be mounted in front of the rear mirror of a vehicle to capture a front view. The right and left side view cameras may be mounted at a right and left side of the vehicle respectively to capture a right side view and left side view. The rear view camera may be mounted at the rear of the vehicle to capture a rear view.

In an exemplary embodiment any of the cameras may include a digital video recorder. Alternatively, other types of cameras with continuous recording capability may also be used.

The camera system 14 may be set up to operate in a trigger mode such that when a trigger command is detected, the camera system captures a photographic image of an object of interest. In another exemplary embodiment, the camera system 14 may be set up to operate in an event mode such that the camera system 14 captures an image or video upon the occurrence of an event. In an alternative embodiment, the camera system 14 may be set up to operate in a mixed mode such that continuous video may be captured for a predetermined period of time.

The network system 15 may include a plurality of computers or servers located in many different geographic locations. The illustrated network system 15 may include, for example, a wide area network (WAN), a local area network (LAN) or the Internet. The network system provides communication among the devices and systems in the integration system 10 using one or more communications protocols, such as, for example, TCP/IP (Transmission Control Protocol/Internet Protocol), CDMA (Code Division Multiple Access) or GSM (Global System for Mobile Communications).

Turning now to FIG. 3, a diagram of a microprocessor system that may be used to implement a system such as the handheld computing device 11 and/or the vehicle computer 13 is illustrated. Shown in FIG. 3 is a multiprocessor system 1000 that may include a first processing element 1070 and a second processing element 1080. While two processing elements 1070 and 1080 are shown, it is to be understood that an embodiment of system 1000 may also include only one such processing element.

System 1000 is illustrated as a point-to-point interconnect system, wherein the first processing element 1070 and second processing element 1080 are coupled via a point-to-point interconnect 1050. It should be understood that any or all of the interconnects illustrated in FIG. 3 may be implemented as multi-drop bus rather than point-to-point interconnect.

As shown in FIG. 3, each of processing elements 1070 and 1080 may be multicore processors, including first and second processor cores (i.e., processor cores 1074a and 1074b and processor cores 1084a and 1084b). Such cores 1074, 1074b, 1084a, 1084b may be configured to execute instruction code.

Each processing element 1070, 1080 may include at least one shared cache 1896. The shared cache 1896a, 1896b may store data (e.g., instructions) that are utilized by one or more components of the processor, such as the cores 1074a, 1074b and 1084a, 1084b, respectively. For example, the shared cache may locally cache data stored in a memory 1032, 1034 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the present invention is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There may be a variety of differences between the processing elements 1070, 1080 in terms of a spectrum of metrics of merit including architectural, microarchitectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

First processing element 1070 may further include memory controller logic (MC) 1072 and point-to-point (P-P) interfaces 1076 and 1078. Similarly, second processing element 1080 may include a MC 1082 and P-P interfaces 1086 and 1088. As shown in FIG. 3, MC's 1072 and 1082 couple the processors to respective memories, namely a memory 1032 and a memory 1034, which may be portions of main memory locally attached to the respective processors. While MC logic 1072 and 1082 is illustrated as integrated into the processing elements 1070, 1080, for alternative embodiments the MC logic may be discrete logic outside the processing elements 1070, 1080 rather than integrated therein.

First processing element 1070 and second processing element 1080 may be coupled to an I/O subsystem 1090 via P-P interconnects 1076, 1086 and 1084, respectively. As shown in FIG. 3, I/O subsystem 1090 may include P-P interfaces 1094 and 1098. Furthermore, I/O subsystem 1090 may include an interface 1092 to couple I/O subsystem 1090 with a high performance graphics engine 1038. In one embodiment, a bus may be used to couple graphics engine 1038 to I/O subsystem 1090. Alternately, a point-to-point interconnect 1039 may couple these components.

In turn, I/O subsystem 1090 may be coupled to a first bus 1016 via an interface 1096. In one embodiment, first bus 1016 may be a Peripheral Component Interconnect (PCI) bus, or a bus such as a PCI Express bus or another third generation I/O interconnect bus, although the scope of the present invention is not so limited.

As shown in FIG. 3, various I/O devices 1014 may be coupled to first bus 1016, along with a bus bridge 1018 which may couple first bus 1016 to a second bus 1010. In one embodiment, second bus 1010 may be a low pin count (LPC) bus. Various devices may be coupled to second bus 1010 including, for example, a keyboard/mouse 1012, communication device(s) 1026 (which may in turn be in communication with the computer network), and a data storage unit 1019 such as a disk drive or other mass storage device which may include code 1030, in one embodiment. The code 1030 may include instructions for performing embodiments of one or more of the methods described herein. Further, an audio I/O 1024 may be coupled to second bus 1010.

Note that other embodiments are contemplated. For example, instead of the point-to-point architecture of FIG. 3, a system may implement a multi-drop bus or another such communication topology. Also, the elements of FIG. 3 may alternatively be partitioned using more or fewer integrated chips than shown in FIG. 3.

FIG. 4 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 4, a processing element may alternatively include more than one of the processor core 200 illustrated in FIG. 4. The processor core 200 may be a single-threaded core or, for at least one embodiment, the processor core 200 may be multithreaded in that it may include more than one hardware thread context (or “logical processor”) per core.

FIG. 4 also illustrates a memory 270 coupled to the processor 200. The memory 270 may be any of a wide variety of memories (including various layers of memory hierarchy) as are known or otherwise available to those of skill in the art. The memory 270 may include one or more code 213 instruction(s) to be executed by the processor 200 core, wherein the code 213 may implement one or more of the methods described herein. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end 210 may also include register renaming logic 225 and scheduling logic 230, which generally allocate resources and queue the operation corresponding to the convert instruction for execution.

The processor 200 is shown including execution logic 250 having a set of execution units 255-1 through 255-N. Some embodiments may include a number of execution units dedicated to specific functions or sets of functions. Other embodiments may include only one execution unit or one execution unit that may perform a particular function. The illustrated execution logic 250 performs the operations specified by code instructions.

After completion of execution of the operations specified by the code instructions, back end logic 260 retires the instructions of the code 213. In one embodiment, the processor 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 4, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

With continuing reference to FIGS. 1A and 5A, a method of integrating handheld computing device 11, vehicle computer 13 and 360 degree field of view camera system 14 to capture images is shown. The method may be implemented as a set of logic instructions and/or firmware stored in a machine- or computer-readable medium such as random access memory (RAM), read only memory (ROM), programmable ROM (PROM), flash memory, etc., in configurable logic such as, for example, programmable logic arrays (PLAs), field programmable gate arrays (FPGAs), complex programmable logic devices (CPLDs), in fixed-functionality hardware using assembly language programming and circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method may be written in any combination of one or more programming languages, including an object oriented programming language such as C++ or the like and conventional procedural programming languages, such as the “C” programming language or similar programming languages. Moreover, the method may be implemented using any of the aforementioned circuit technologies.

At process block 30, handheld computing device 11 connects to vehicle computer 13 using any wireless communication protocol (e.g., Bluetooth). For example, when a user with a handheld computing device enters a wireless communication range of the vehicle computer, a handshake communication protocol will take place between the handheld computing device and the vehicle computer to effectively connect the handheld computing device to the vehicle computer.

At process block 31, a user aims the handheld computing device 11 towards an object of interest (i.e., an object which the user wants a photographic image of). For example, a user located inside a vehicle directs a mobile phone at an object outside the vehicle. The user clicks a button on the user interface of the mobile phone to initiate a photo process, at process block 32.

When the user clicks the button, the handheld computing device 11 is directed to generate a trigger command and to obtain orientation data of the handheld computing device, at process block 33. The handheld computing device may obtain orientation data from an electronic compass, global positioning system and/or image data. The orientation data provides location information of the handheld computing device relative to the object of interest.

For example, when the user clicks the button, the electronic compass determines the location of the handheld computing device 11 at the particular point in time, such as, for example, 320° North-West. This interaction may indicate that the handheld computing device is facing North-West at 320°, wherein the location is representative of the position of the object of interest. The handheld computing device may transmit this information to the vehicle computer 13 along with the trigger command.

At process block 34, the vehicle computer 13 evaluates the orientation data and selects one or more of the external cameras in the 360 degree field of view camera system 14 to capture image data. The vehicle computer selects the camera(s) that is able to capture an image at the location of the handheld computer indicated from the orientation data. In this regard, each camera in the camera system may have a limited field of view. Accordingly, the camera(s) with a field of view which encompasses or overlaps the location provided in the orientation data is selected to capture the image.

Accordingly, the vehicle computer 13 may send the received trigger command to the selected camera(s) and the camera(s) captures image data. Of particular note is that the image data may include a photographic image of the object of interest without depictions of the interior of the car. The captured image data may be sent to the vehicle computer.

At process block 35, the vehicle computer 13 crops the image data from the selected camera(s). The vehicle computer may crop the image data using any image processing techniques, such as, for example, feature matching techniques. The cropped image removes any portion of the image which falls outside the desired angle of view. The cropped image is transmitted to the handheld computing device at process block 36 for review by the user.

FIG. 5B shows a method 37 of conducting image captures. The method 37 may be implemented as a set of logic instructions and/or firmware stored in a machine- or computer-readable medium such as RAM, ROM, PROM, flash memory, etc., in configurable logic such as, for example, PLAs, FPGAs, CPLDs, in fixed-functionality hardware using assembly language programming and circuit technology such as, for example, ASIC, CMOS or TTL technology, or any combination thereof. Illustrated device process block 38 provides for receiving information from a user interface to initiate a trigger command, wherein orientation data and the trigger command may be sent to a remote computing system associated with a vehicle at device process block 39. As already noted, the orientation data may include location data such as, for example, image data, digital compass data, GPS data, etc., for an object of interest.

System process block 40 may receive the orientation data and the trigger command from the remote computing device, wherein image data may be obtained from one or more devices external to a vehicle at system process block 41 in response to the trigger command and based on the orientation data. System process block 41 may also provide for cropping the image data to obtain cropped image data. At response (e.g., responsive data) may be transmitted to the remote computing device at system process block 42 based on the image data. Illustrated device process block 43 receives the response from the remote computing system. The response may also be presented to the user for review on the handheld computing device.

Turning to FIG. 6A, a user, located inside a vehicle, wishes to capture a picture of an object, such as, for an example, a tree which is located outside the vehicle. The user aims the handheld computing device (e.g., mobile phone) at the object and clicks a button on the user interface of the phone. The handheld computing device generates a trigger command and obtains identification data which is sent to the vehicle computer in FIG. 6B.

In FIG. 6B, the handheld computing device's orientation relative to the object of interest is illustrated with respect to the field of view of the 360 degree field of view camera system. The vehicle computer selects a camera, such as, for example, the right side view camera to capture an image of the object of interest (i.e., tree). The image is returned to the vehicle computer for further processing (i.e., cropping) and the processed image is returned to the handheld computing device for the user to view.

### Additional Notes and Examples

Example 1 may provide an apparatus to conduct image captures. The apparatus may include a user interface, a first receive module to receive information from the user interface to initiate a trigger command, an orientation module to send orientation data and the trigger command to a remote computing system associated with a vehicle, and a second receive module to receive a response from the remote computing system, wherein the response includes one or more images of a scene external to the vehicle.

Example 2 may include the apparatus of example 1, wherein the orientation data is to include location data relative to an object of interest.

Example 3 may include the apparatus of example 2, wherein the location data is to include one or more of image data, digital compass data and global positioning system data for the object of interest.

Example 4 may include the apparatus of example 2, wherein the object of interest is to be an object of which a user is requesting a photographic image.

Example 5 may include at least one computer readable medium comprising one or more instructions that when executed on a computing device configure the computing device to receive information from a user interface to initiate a trigger command, send orientation data and the trigger command to a remote computing system associated with a vehicle, and receive a response from the remote computing system, wherein the response includes one or more images of a scene external to the vehicle.

Example 6 may include the at least one computer readable medium of example 5, wherein the orientation data is to include location data relative to an object of interest.

Example 7 may include the at least one computer readable medium of example 6, wherein the location data is to include one or more of image data, digital compass data and global positioning system data for the object of interest.

Example 8 may include the at least one computer readable medium of example 6, wherein the object of interest is to be an object of which a user is requesting a photographic image.

Example 9 may include the at least one computer readable medium of example 5, wherein the external images are to include cropped data images.

Example 10 may include at least one computer readable medium comprising one or more instructions that when executed on a computing device configure the computing device to receive a trigger command and orientation data from a remote computing device, obtain image data from one or more devices external to a vehicle in response to the trigger command and based on the orientation data, and transmit data to the remote computing device.

Example 11 may include the at least one computer readable medium of example 10, further comprising one or more instructions that when executed on a processor configure the processor to select one or more of the devices external to the vehicle to obtain the image data based on the received orientation data.

Example 12 may include the at least one computer readable medium of example 10, further comprising one or more instructions that when executed on a processor configure the processor to crop the image data from the one or more devices external to the vehicle.

Example 13 may include the at least one computer readable medium of example 12, wherein the data transmitted to the remote computing device is to include the cropped image from the data obtained from the one or more external devices.

Example 14 may include the at least one computer readable medium of example 10, wherein the orientation data is to include location data relative to an object of interest.

Example 15 may include the at least one computer readable medium of example 14, wherein the location data is to include one or more of image data, digital compass data and global positioning system data for the object of interest.

Example 16 may include the at least one computer readable medium of example 14, wherein the object of interest is to be an object of which a user is requesting a photographic image.

Example 17 may include the at least one computer readable medium of example 10, wherein the image data is to be obtained from cameras which collectively form a 360 degree field of view camera system including a front view camera, a right side view camera, a left side view camera and a rear view camera.

Example 18 may include an apparatus to conduct image captures, comprising a receive module to receive a trigger command and orientation data from a remote computing device, an obtain module to obtain image data from one or more devices external to a vehicle in response to the trigger command and based on the orientation data and a transmit module to transmit data to the remote computing device.

Example 19 may include the apparatus of example 18, further comprising a select module to select one or more of the devices external to the vehicle to obtain the image data based on the received orientation data.

Example 20 may include the apparatus of example 18, further comprising a crop module to crop the image data from the one or more devices external to the vehicle.

Example 21 may include the apparatus of example 20, wherein the data transmitted to the remote computing device is to include the cropped image from the data obtained from the one or more external devices.

Example 22 may include the apparatus of example 18, wherein the orientation data is to include location data relative to an object of interest.

Example 23 may include the apparatus of example 22, wherein the location data is to include one or more of image data, digital compass data and global positioning system data for the object of interest.

Example 24 may include the apparatus of example 22, wherein the object of interest is to be an object of which a user is requesting a photographic image.

Example 25 may include the apparatus of example 18, wherein the image data is to be obtained from cameras which collectively form a 360 degree field of view camera system including a front view camera, a right side view camera, a left side view camera and a rear view camera.

Example 26 may include a method to conduct image captures, comprising receiving information from a user interface to initiate a trigger command, sending orientation data and the trigger command to a remote computing system associated with a vehicle, and receiving a response from the remote computing system, wherein the response includes one or more images of a scene external to the vehicle.

Example 27 may include a method to conduct image captures, comprising receiving a trigger command and orientation data from a remote computing device, obtaining image data from one or more devices external to a vehicle in response to the trigger command and based on the orientation data, and transmitting data to the remote computing device.

Example 28 may include an apparatus to conduct image captures, comprising means for performing any one of the methods of examples 27 to 28.

Embodiments of the present invention are applicable for use with all types of semiconductor integrated circuit (“IC”) chips. Examples of these IC chips include but are not limited to processors, controllers, chipset components, programmable logic arrays (PLA), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size may be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention may be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software.

The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like.

The machine readable medium may include any mechanism for storing, transmitting, or receiving information in a form readable by a machine, and the medium may include a medium through which the program code may pass, such as antennas, optical fibers, communications interfaces, etc. Program code may be transmitted in the form of packets, serial data, parallel data, etc., and may be used in a compressed or encrypted format.

Program code, or instructions, may be stored in, for example, volatile and/or non-volatile memory, such as storage devices and/or an associated machine readable or machine accessible medium including, but not limited to, solid-state memory, hard-drives, floppy-disks, optical storage, tapes, flash memory, memory sticks, digital video disks, digital versatile discs (DVDs), etc., as well as more exotic mediums such as machine-accessible biological state preserving storage.

The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. An apparatus to conduct image captures, comprising:
a user interface;
a first receive module to receive information from the user interface to initiate a trigger command;
an orientation module to send orientation data and the trigger command to a remote computing system associated with a vehicle; and
a second receive module to receive a response from the remote computing system, wherein the response includes one or more images of a scene external to the vehicle.

2. The apparatus of claim 1, wherein the orientation data is to include location data relative to an object of interest.

3. The apparatus of claim 2, wherein the location data is to include one or more of image data, digital compass data and global positioning system data for the object of interest.

4. The apparatus of claim 2, wherein the object of interest is to be an object of which a user is requesting a photographic image.

5. At least one computer readable medium comprising one or more instructions that when executed on a computing device configure the computing device to:
receive information from a user interface to initiate a trigger command;
send orientation data and the trigger command to a remote computing system associated with a vehicle; and
receive a response from the remote computing system, wherein the response includes one or more images of a scene external to the vehicle.

6. The at least one computer readable medium of claim 5, wherein the orientation data is to include location data relative to an object of interest.

7. The at least one computer readable medium of claim 6, wherein the location data is to include one or more of image data, digital compass data and global positioning system data for the object of interest.

8. The at least one computer readable medium of claim 6, wherein the object of interest is to be an object of which a user is requesting a photographic image.

9. The at least one computer readable medium of claim 5, wherein the external images are to include cropped data images.

10. At least one computer readable medium comprising one or more instructions that when executed on a computing device configure the computing device to:
receive a trigger command and orientation data from a remote computing device;
obtain image data from one or more devices external to a vehicle in response to the trigger command and based on the orientation data; and
transmit responsive data to the remote computing device based on the image data.

11. The at least one computer readable medium of claim 10, further comprising one or more instructions that when executed on a processor configure the processor to:
select one or more of the devices external to the vehicle to obtain the image data based on the received orientation data.

12. The at least one computer readable medium of claim 10, further comprising one or more instructions that when executed on a processor configure the processor to:
crop the image data from the one or more devices external to the vehicle.

13. The at least one computer readable medium of claim 12, wherein the responsive data transmitted to the remote computing device is to include the cropped image data.

14. The at least one computer readable medium of claim 10, wherein the orientation data is to include location data relative to an object of interest.

15. The at least one computer readable medium of claim 14, wherein the location data is to include one or more of image data, digital compass data and global positioning system data for the object of interest.

16. The at least one computer readable medium of claim 14, wherein the object of interest is to be an object of which a user is requesting a photographic image.

17. The at least one computer readable medium of claim 10, wherein the image data is to be obtained from cameras which collectively form a 360 degree field of view camera system including a front view camera, a right side view camera, a left side view camera and a rear view camera.

18. An apparatus to conduct image captures, comprising:
a receive module to receive a trigger command and orientation data from a remote computing device;
an obtain module to obtain image data from one or more devices external to a vehicle in response to the trigger command and based on the orientation data; and
a transmit module to transmit responsive data to the remote computing device based on the image data.

19. The apparatus of claim 18, further comprising:
a select module to select one or more of the devices external to the vehicle to obtain the image data based on the received orientation data.

20. The apparatus of claim 18, further comprising:
a crop module to crop the image data from the one or more devices external to the vehicle.

21. The apparatus of claim 20, wherein the responsive data transmitted to the remote computing device is to include the cropped image data.

22. The apparatus of claim 18, wherein the orientation data is to include location data relative to an object of interest.

23. The apparatus of claim 22, wherein the location data is to include one or more of image data, digital compass data and global positioning system data for the object of interest.

24. The apparatus of claim 22, wherein the object of interest is to be an object of which a user is requesting a photographic image.

25. The apparatus of claim 18, wherein the image data is to be obtained from cameras which collectively form a 360 degree field of view camera system including a front view camera, a right side view camera, a left side view camera and a rear view camera.
